(19) United States
(12) Patent Application Publication
(10) Pub. No.: US 2017/0320652 A1
(43) Pub. Date: Nov. 9, 2017

(54) Insulation Container Utilizing Novel Layered Design

(71) Applicant: Cullen Schlageter, Clemson, SC (US)

(72) Inventor: Cullen Schlageter, Clemson, SC (US)

(21) Appl. No.: 15/586,609

(22) Filed: May 4, 2017

Related U.S. Application Data
(60) Provisional application No. 62/331,565, filed on May 4, 2016.

(51) Int. Cl. B65D 81/38; A47J 41/00

(52) U.S. Cl. CPC B65D 81/3893; A47J 41/0072

(57) ABSTRACT

A container having improved insulation properties with an inner structure received into an outer structure defining an inner cavity and having a flat configuration and an erected configuration; a bottom insulating cavity defined by a bottom panel, a bottom rear wall, and bottom lateral walls when the inner structure is in an erected configuration; a first side insulating cavity defined by a first side panel, a first side panel lateral wall and a first side panel top wall when the inner structure is in the erected configuration; a second insulating cavity defined by a second side panel and a second side top wall when the inner structure is in an erected configuration and cooperatively associated with an outer structure; and, a top insulating cavity defined by a top panel and a top ridge when the inner structure is in an erected configuration and operatively associated with the outer structure.

### BACKGROUND OF THE INVENTION

### Field of the Invention

This invention is related to insulated shipping systems having an layered arrangement that can be expanded in its operation to provide for a storage and shipping container reducing or preventing temperature changes between the interior of the container and the surrounding environment.

### Description of the Related Art

There is currently no easily manufactural or cost-efficient way to separate layers of low-emissivity films in order to generate a measurable R-value, which remains flexible, compressible, and self-supporting laterally.

The materials currently used to insulate cold chain packages are not compressible, and are relatively heavy due to excess material needed to insulate. Multi-layered insulation systems are not traditionally used in packaging as they are not cost efficient to manufacture, require expensive material, and provide less utility unlike the claimed invention.

For example, U.S. Pat. No. 5,706,969 is directed to an insulated container used for example as a cooler box, a thermos flask, or an insulated lunch box, a suitable insulating material for such a container and a method for its manufacture. It is a made with an insulating layer between inner and outer walls of a double walled container with the inner and outer walls joined together as one, and has an insulating material, made by filling a bag with a low thermal conductivity gas comprising at least one of gases such as Xenon, Krypton, and Argon, disposed between the inner and outer walls.

German Patent Publication DE 3820310 is directed to a double-walled container for heating, cooking, serving, transporting, storing, and keeping item and fluids warm. U.S. Pat. No. 9,139,352 is directed to an insulating device having an aperture having a waterproof closure which allows access to the chamber within the insulating device where in the insulating device includes outer sides with an inter insulation material.

Generally, insulation works by slowing the transfer of heat, which can occur in three ways: conduction, convection, and radiation. Conduction is the transfer of heat as it moves through an object. Heat transfers when one molecule excites the adjacent molecule thus transferring the heat. Convection occurs when heat transfers in a fluid. Radiation is when heat transfers through electromagnetic waves. Insulation is designed to restrict or prevent these types of heat transfer. Generally, insulation absorbs the heat and slows its movement.

One method of insulating a shipping container, such as one designed to ship frozen foods, is to construct a container or line the container with an insulating material such as expanded polystyrene or closed-cell extruded polystyrene foam. Typically, this type is insulation is composed of 95% air or greater. However, such insulation materials have significant disadvantages including some studies showing that it is a carcinogen.

Further, this design does not allow for the container to be collapsed for storage or for a linear manufacturing method. It would be advantageous for a container to have a collapsed configuration where the container can be flattened and stored prior to use. It would also be advantageous for the container to be constructed without the need for the container to have a generally three dimensional shape such as when polystyrene or other insulating materials are used.

Another insulation material is fiberglass which also has significant disadvantages. For example, fiberglass is a potential carcinogen, has formaldehyde off-gassing from resins used in is commercial applications, and direct contact with fiberglass and exposure to airborne fiberglass dust can irritate the skin, eyes, nose, and throat.

Therefore, it is an object of the present invention to provide for a low cost, easily manufactured insulated container without the disadvantages of prior technologies.

### BRIEF SUMMARY OF THE INVENTION

The above objectives are accomplished by providing an insulated container comprising: an outer layer; an intermediate layer attached to the outer layer having a protrusion with cuts and fold to define an intermediate void having insulation properties; an inner layer carried by the outer layer having a protrusion with cuts and fold to define an inner void having insulation properties; a flattened position wherein the protrusion are generally adjacent to the walls of the respective layers; and, an operational position where in the protrusion are expanded to define the respective void.

The invention can include a bottom portion having layers and voids and a lid having layers and voids. The invention can include an outer layer; an protrusion assembly; an intermediate layer included in the protrusion assemble having a protrusion with cuts and fold to define an intermediate void having insulation properties; and, an inner layer included in the protrusion assembly having a protrusion with cuts and fold to define an inner void having insulation properties; and, wherein the protrusion assembly is receive on the a container defined by the outer layer. One or the layers is paper and one of the layer is a polymer. One or the layers include a coating to provide for physical properties.

The claimed invention is compressible, recoverable, and self-supporting; allowing it to be broken down in a container and shipped, thus saving space in distribution.

Additionally, the claimed invention is less dense than traditional cold chain liners, saving distributers fuel costs. Additionally, the container can be manufactured in a layered configuration allowing for raw material to be stored on rolls and the generally flat manufacturing line utilized. The invention can be thought of as a series of nested containers defining voids within the container to insulate the container from the surrounding environment.

In one embodiment, the invention is a container having improved insulation properties; an inner structure attached to an outer structure where the inner structure and outer structure form a container and define an outer cavity; a flat configuration where the inner structure is carried by the outer structure and an internal layer is positioned between the inner structure and outer structure; a bottom insulating cavity defined by a bottom panel, a bottom rear wall, bottom lateral walls, and outer structure when the container is in an erected configuration; a first side insulating cavity defined by a first side panel, a first side panel lateral wall, a first side panel top wall, and the outer structure when the container is in an erected configuration; a second insulating side cavity defined by a second side panel, a second side panel top wall, and the outer structure when the container is in an erected configuration; a top insulating cavity defined by a top panel and the outer structure when the container is in an erected configuration; and, a top flap having a vertical wall disposed adjacent to a top ridge and a horizontal flap disposed over the top when the container is in an erected configuration.

The second side panel can extend to the interior of the outer structure farther than the first side panel. A portion of the second side panel can fold onto the first side panel lateral wall. A plurality of sublayers can be included in the internal layer arranged in an offset sublayer configuration and disposed between the outer structure and the inner structure. An offset adhesion pattern can be configured to apply adhesion to each sublayer to provide the offset sublayer configuration. An overlapping perforation coding pattern can be defined in the sublayers of the internal layer. A plurality of sublayer can define insulating cavities. A bottom flap can be attached to the second side panel.

In one embodiment, the container can have improved insulation properties comprising: an inner structure operatively associated with an outer structure; a first set of opposing side insulating cavities including a pair of first side panels; a second set of opposing side insulating cavities including a pair of second panels wherein the pair of first side panels and the second pair of side panels and the second pair of side panels define an inner cavity and wherein the first side panels extend into the inner cavity farther than the second side panels; a set of bottom insulating cavities defined by a pair of bottom panels, bottom rear walls, and bottom lateral walls; and, a top insulating cavity defined by a pair of top panels. The outer structure can be affixed to the inner structure and the outer structure and inner structure are cooperatively associated to have a flat configuration and an erected configuration. A plurality of sublayers disposed between the inner structure and the outer structure in an offset arrangement. A top flap can form a top ridge when the inner structure is in its erected configuration.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a top down cross-section of the invention;

FIG. 2 shows side views of components of the invention;

FIG. 3 shows a top down view of components of the invention;

FIG. 4 shows a perspective view of components of the invention;

FIG. 5 shows a perspective view of components of the invention;

FIG. 6 shows a perspective view of components of the invention;

FIG. 7 shows a side view of components of the invention;

FIG. 8A shows a side view of components of the invention;

FIG. 8B shows a side view of components of the invention;

FIG. 9 shows a side view of components of the invention;

FIG. 10 shows a side view of components of the invention;

FIG. 11A shows a perspective view of components of the invention;

FIG. 11B shows a cross-section of components of the invention;

FIG. 12A shows a perspective view of components of the invention;

FIG. 12B shows a perspective view of components of the invention;

FIG. 12C shows a top down view of components of the invention; and,

FIG. 12D shows a top down view of components of the invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF THE INVENTION

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

As stated above, there is not currently a manufacturable and cost-efficient way to separate layers of low-emissivity films in order to generate a measurable R-value, which remains flexible and compressible. The invention claimed here solves this problem. Further, there is not a manufacturable and cost-efficient way to make a layered container with the proper R-value that can be made from rolled paper board or paper stock.

The claimed invention differs from what currently exists. The claimed invention utilizes a physical structure to accomplish its designed function that is unlike anything that currently exists. By including the voids in the layers and protrusions and having successive layers, the invention constructs an airspace utilizing minimal support material, thus restricting thermal bridging and reducing heat flow by conduction as well as reducing material costs and manufacturing costs.

This invention is an improvement on what currently exists. Unlike other designs, the claimed invention is manufacturable through a rolled paper stock process, using low cost materials to produce a superior product that is more compressible than other insulation materials. Additionally, the claimed invention is capable of insulating more efficiently than traditional bulk insulation systems as the thermal resistance in multi-layered insulation systems add linearly with subsequent layers. This allows the claimed system to block heat flow at the same rate as its denser alternatives. As it applies to the field of cold chain packaging, this allows much lighter packages which saves distributers transportation, fuel storage and manufacturing costs.

Traditionally utilized foam/bulk insulation systems require packagers to accept heavy packages that cannot ship compressed, therefore traditional systems cannot efficiently maximize space when not filled with product.

This design is compressible and recoverable, allowing it to be broken down with a package and shipped, and then recover fully when necessary, additionally this design is thinner, allowing it to insulate more efficiently in the same space as other comparable insulation while utilizing less material.

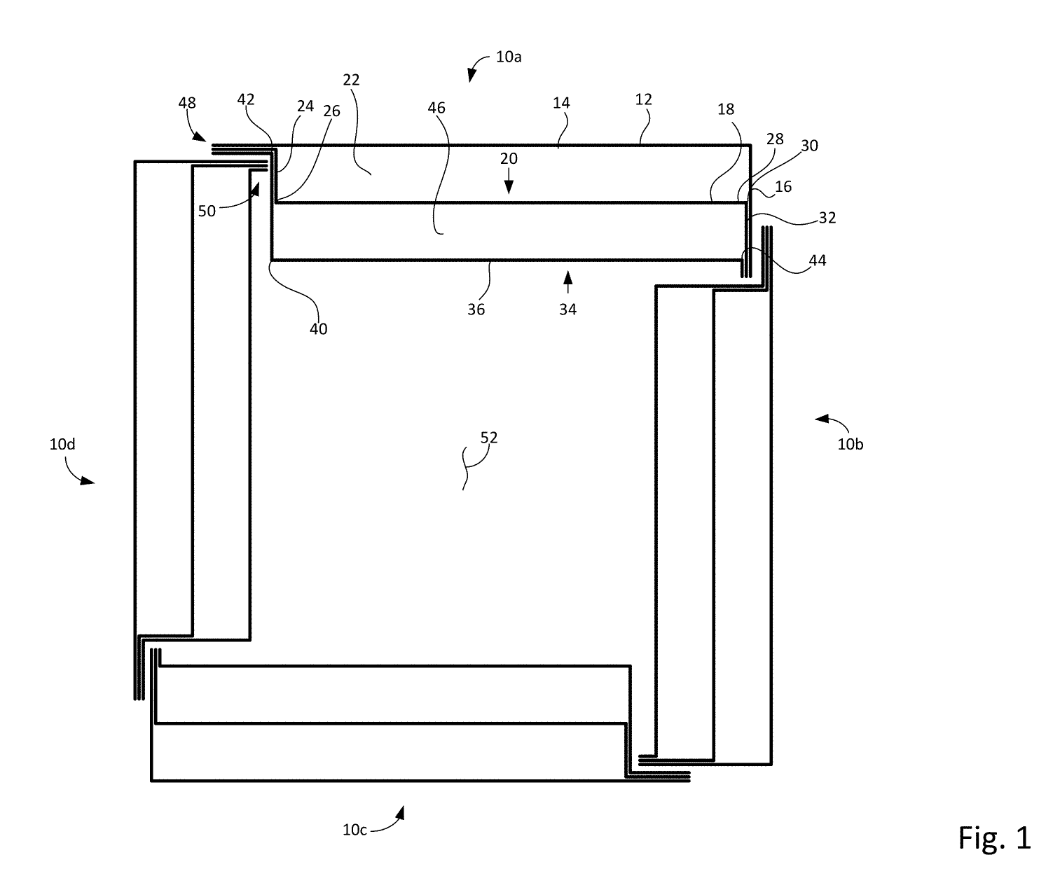

Referring to FIG. 1, the top view of the invention is shown having four side assemblies 10a though 10d. Each of the side assemblies can have multiple layers. The outer layer 12 can have an outer layer fold that generally allows a portion of the outer layer to fold about 90°. The outer rear panel 14 disposed on one side of the fold and the outer side panel 16 disposed on the other side. The outer rear panel of one side assembly can be joined to the outer side panel of an adjoining side assembly so that four side assemblies can form the container. The side assembly can include an intermediate layer 18 that can include an intermediate layer protrusion 20 defining an intermediate void 22. The intermediate protrusion can include a left panel 24 and left fold 26. In one embodiment, the opposite side of the protrusion 28 has a fold 30. In one embodiment, an intermediate right panel 32 is included in the intermediate protrusion and can be secured to the inner side of the outer layer. The intermediate protrusion can include a center panel disposed between the right and left intermediate panels.

A inner layer 34 can include an inner layer protrusion 36 that can include an inner left inner fold 40, inner left outer fold 42, and inner right outer fold 44. The inner layer protrusion defines an inner void 46. The left side 48 can be secured to the rights side of the adjacent side assembly 50 to form the container when four side assemblies are joined accordingly to form main compartment 52.

The side assemblies can be of different lengths along the opposite sides to form a container that is generally rectangular in one embodiment and can be the same length to form a container that is generally a square.

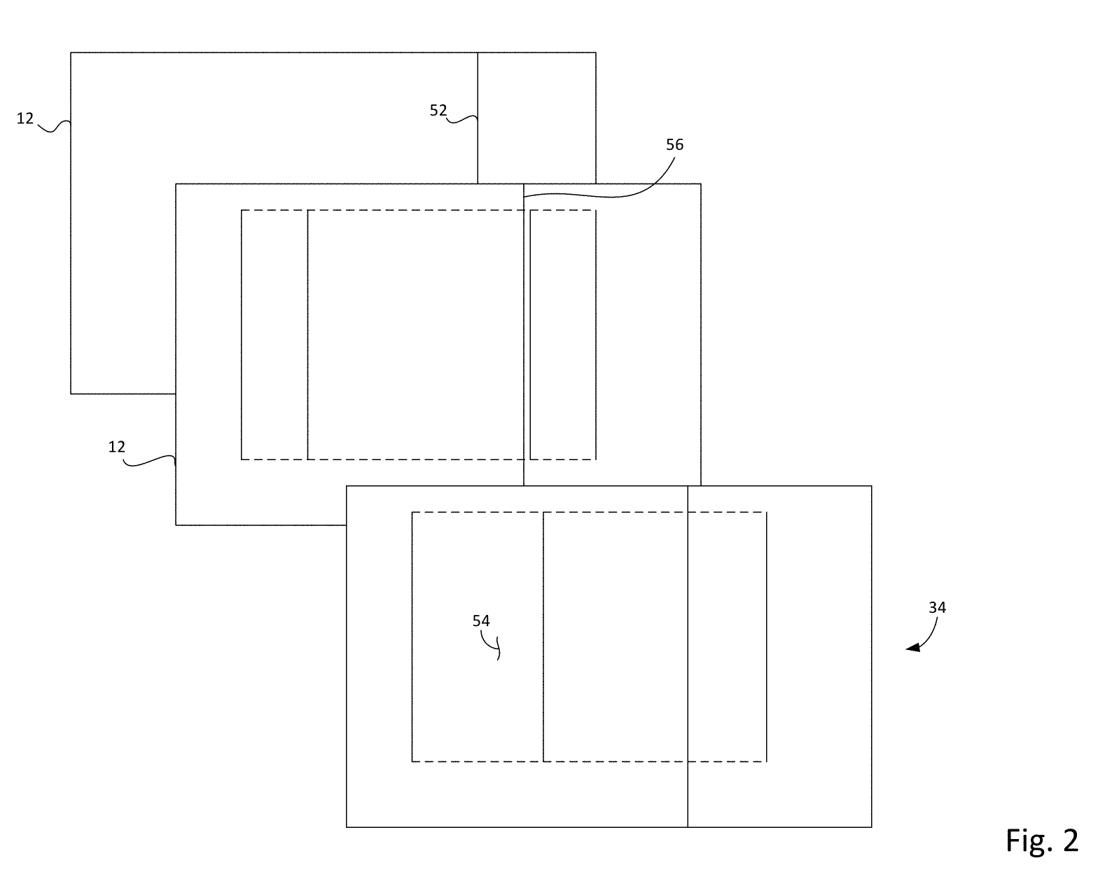

Referring to FIG. 2, the invention is shown with the layers separated. The outer layer 12 can include an outer layer fold 52 allowing the outer layer to be folded generally along a corner or generally 90° in one embodiment. The outer layer can include a coating or printing on the outside wall. The intermediate layer 12 can include an intermediate layer fold 56 allowing the intermediate layer to form a corner and to be nested with the outer layer about the fold to form the container corner. The intermediate layer protrusion 20 can include the intermediate right panel 32 that can be affixed to the inner wall of the outer layer allowing the intermediate layer protrusion to extend away from the intermediate layer.

In one embodiment the intermediate layer protrusion can be attached by a fold to the intermediate layer without being affixed to the outer layer. The intermediate layer protrusion can include the intermediate left panel that can be affixed to the inner layer protrusion. In one embodiment, the intermediate layer protrusion left panel is affixed to a portion of an inner layer protrusion left panel 54. The inner layer 34 can include a film coating on the inner wall to provide for physical properties including water resistance, anti-condensation, light restricting, reduced friction, anti-stick, air tight, semi-permeability, and any combination thereof. In one embodiment, one of the layers can be paper, plastic, film, coated, or any combination thereof.

The inner container can include inner layer fold 58 allowing the inner layer to fold generally 90° to form a corner of the container and to be generally nested into the intermediate layer when constructed. The raw material of the layers can be provided in rolls and unrolled during the manufacturing process. The layers can be affixed to each other in a generally flat arrangement allowing the layers to be manufactured in a generally flat configuration and configured for subsequent assembly into the three dimension a configuration.

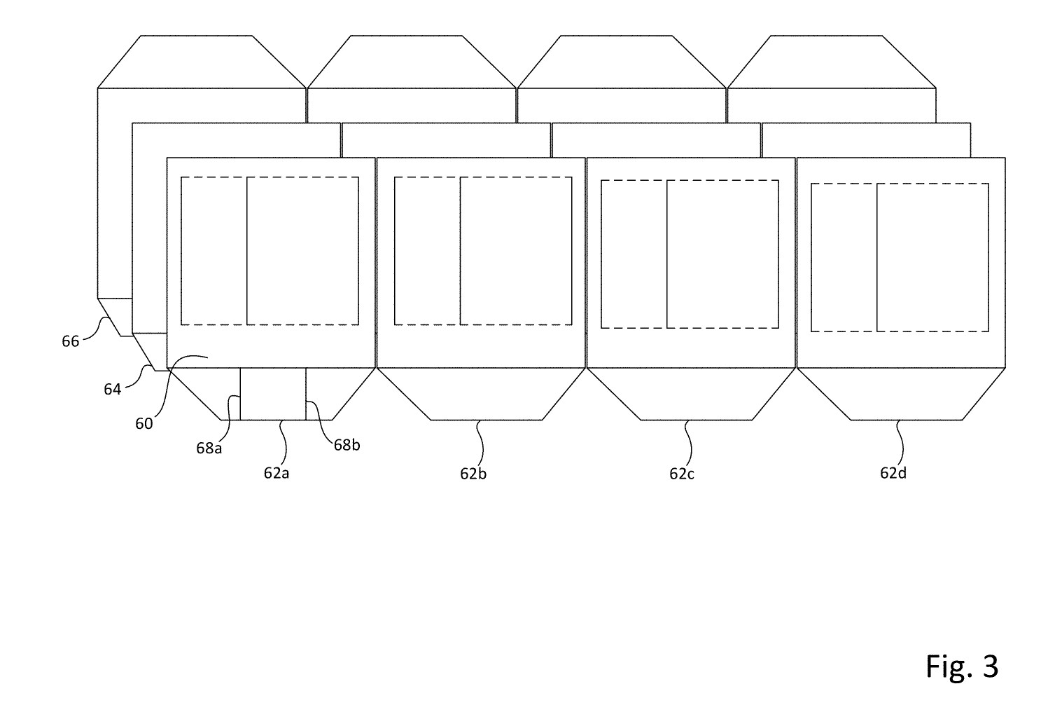

Referring FIG. 3, the layers are shown overlapping with the aside assemblies connected to each other to form a four section arrangement. The side assemblies can be folded to form a square or rectangular container. The protrusions can be disposed on the layers to provide a lower area 60 that can provide for a void to assist with the insulation properties of the container. Each layer can include a bottom portion made from sections such as inner layer bottom sections 62a through 62d, intermediate layer bottom section 64, and outer layer bottom section 66. In one embodiment, each of the bottom portions of each layer can define voids to further provide insulation properties. In one embodiment, the protrusion can extend to the bottom edge of the respective layer and the outer layer can include a bottom portion to form the bottom of the container. In one embodiment, the bottom portions can include slats 68a and 68b that can support the bottom portion disposed above the slats to provide additional support for the contents of the container.

The protrusions can be disposed below the upper edge of the respective layer allowing for a lid to be placed on the erected container. The lid can be separated from the layers. In one embodiment, the lid can include lid portions that are attached to the respective layers. When the lid portions are folded inwards, the lid having voids is provided to assist with the insulating properties of the container. There can be multiple layers in the lid of a single layer in the lid. The bottom and lid can include a coating, film, or other substance to provide the physical properties as with the side assemblies.

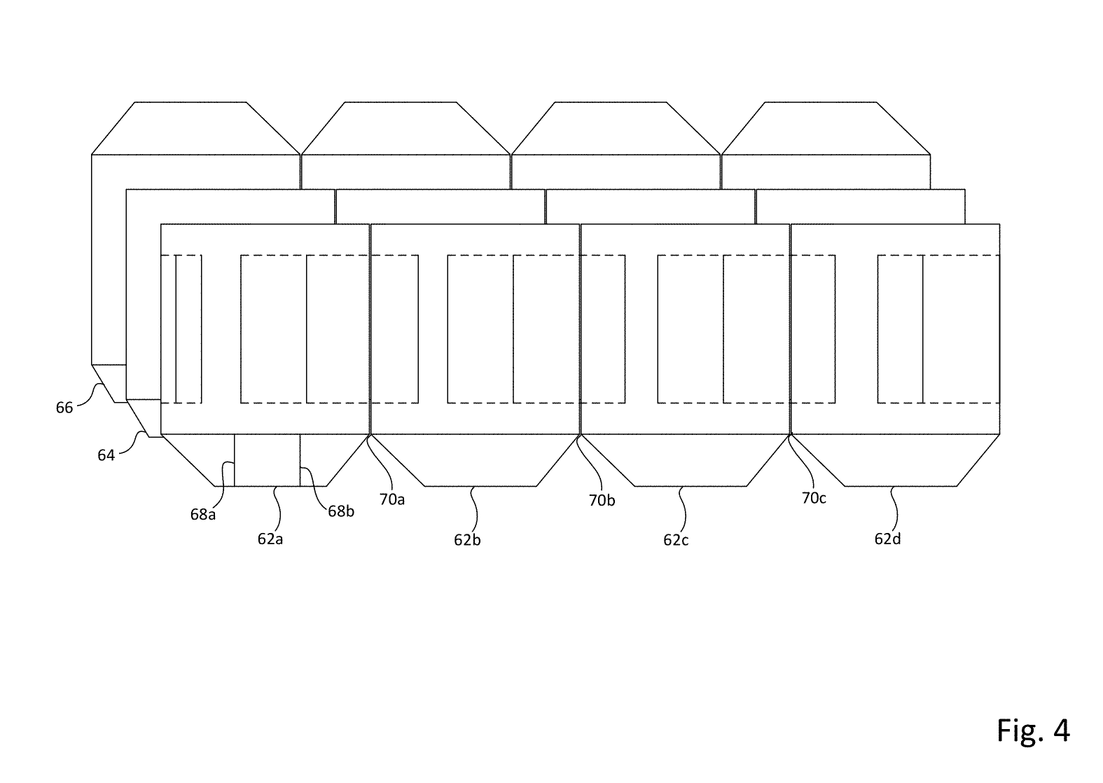

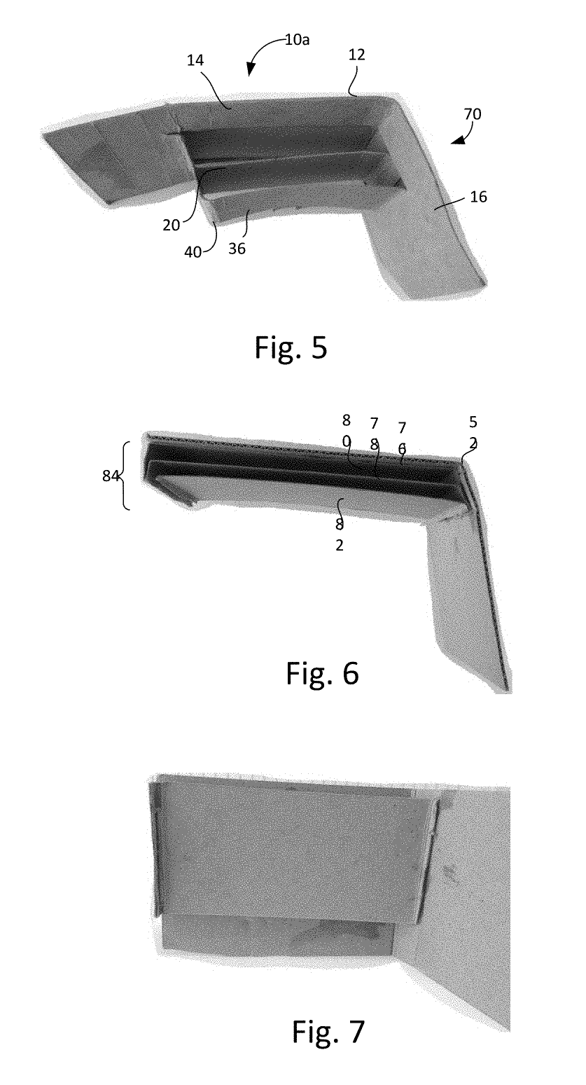

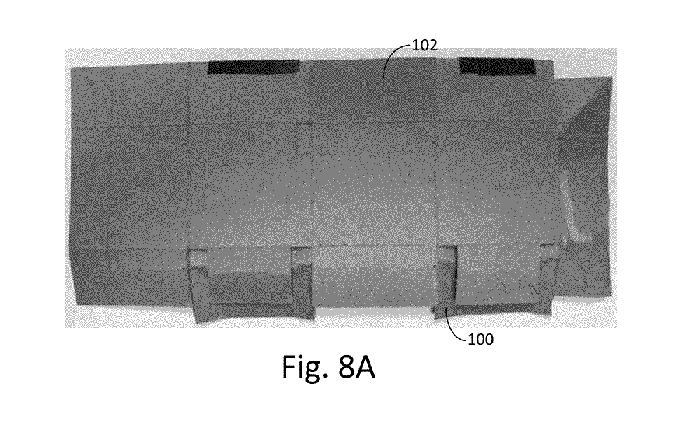

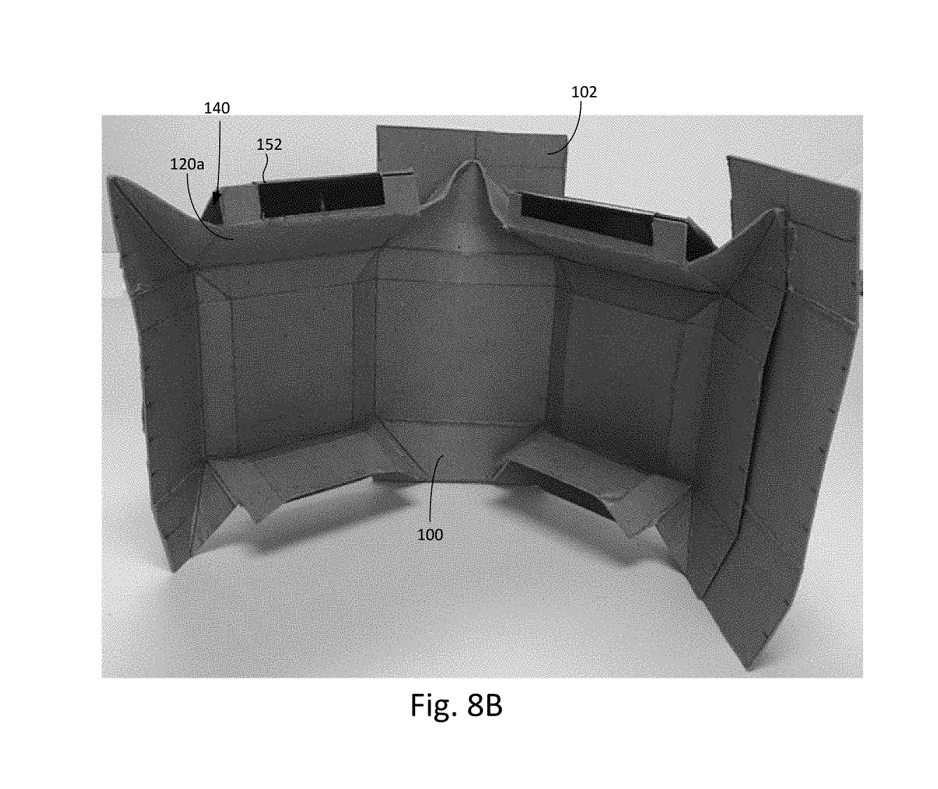

In one embodiment shown in FIG. 4, the protrusion can be disposed over the corner folds 70a through 70c. Referring to FIG. 5, the side assembly 10a is shown form the top view. The outer wall 72 of the container include the inner layer, intermediate layer, and outer layer. The voids provide for insulation properties and include the folds allowing the container to be flattened for storage and transportation and erected for operation. Referring to FIG. 6, one embodiment is shown where the outer layer is corrugated and include the outer layer fold 52. The intermediate protrusion includes a rear wall 76 that can be affixed to the outer layer or inserted into a space defined by the outer layer. A front wall 78 can be included to defined first void 80. The inner layer protrusion can be defined by inner wall 82 that can be affixed to the intermediate protrusion, outer wall, intermediate layer, inner layer, or any combination thereof. The protrusions can be arranged in a separate protrusion assembly 84 that can be affixed to the outer layer or can be received into an opening in a container having an outer layer. FIG. 7 shows the protrusion assembly affixed to the outer layer.

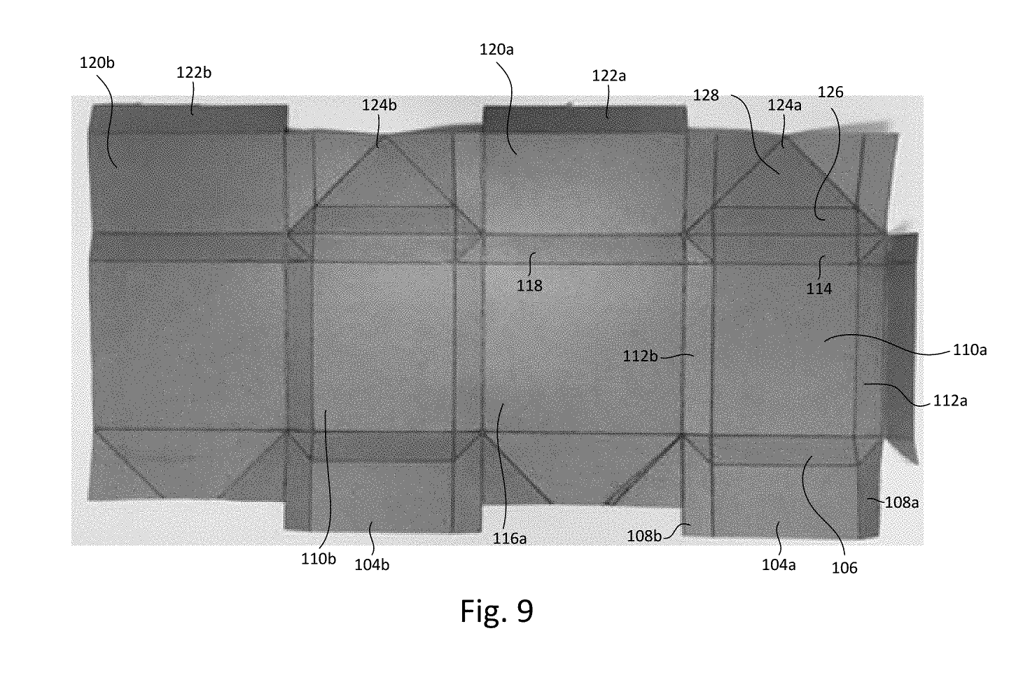

Referring to FIG. 8, another embodiment is shown. An inner structure 100 can be attached to an outer structure 102 where the inner structure and the outer structure can form a container. The container can include an inner cavity for receiving and storing items. The inner structure and the outer structure are shown in a flat configuration which is advantageous for the manufacturing process and storing the invention prior to erecting the inner and outer structures. In one embodiment, the outer structure can be separated from the inner structure. In this embodiment, the outer structure can form a container such as a box when erected and receive the inner structure when it is erected.

Referring to FIG. 8B, the inner structure 100 and the outer structure are affixed to each other and shown in an partially erected configuration. In one embodiment, the top insulating cavity 140 is defined by a top panel 120a having a top portion 152.

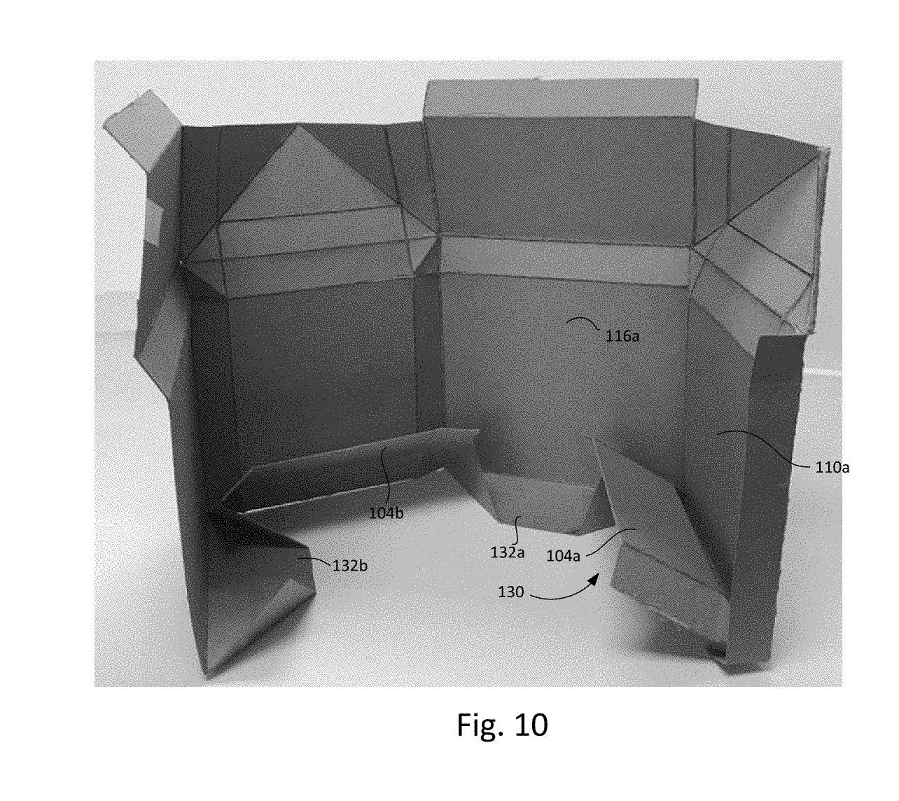

Referring to FIG. 9, one embodiment of the inner structure is shown in further detail. A bottom panel 104a can be included in the inner structure corresponding to once side of the erected structure in one embodiment. A corresponding bottom panel 104b can be included in the inner structure. The bottom panels can be attached to a bottom panel rear wall 106 and to bottom lateral walls 108a and 108b. When cooperatively associated with the outer structure, the bottom panel, bottom rear wall, and bottom lateral walls can define a bottom insulating cavity when the inner structure is in an erected configuration.

A pair of first side panels 110a and 110b can be included in the inner structure. The first side panels can be attached to side panel lateral walls 112a and 112b and a side panel top wall 114. When the inner structure is in the erected configuration, the side panel, side panel lateral walls, first side panel top wall, and the outer structure can define a first side insulating cavity. The first side insulating cavity can further be defined by the bottom rear wall. A pair of second side panels 116a and 116b can be included in the inner structure. A second side panel top wall 118 can be attached to one of the second side panels. A second side panel and second side panel top can define a second insulating cavity. The second side cavity can be further defined by the outer structure and the inner structure and the outer structure are cooperatively associated to form a container.

A pair of top panels 120a and 120b can be included in the inner structure and define a top insulating cavity when cooperatively associated with the outer structure. The top panels can include a top flaps 122a and 122b that can form a top ridge when the inner structure is in its erected configuration. The top ridge can section the top insulating cavity. In one embodiment, the inner structure can include a pair of top flaps 124a and 124b. The top flaps can include a top flap vertical portion 126 and a horizontal portion 128.

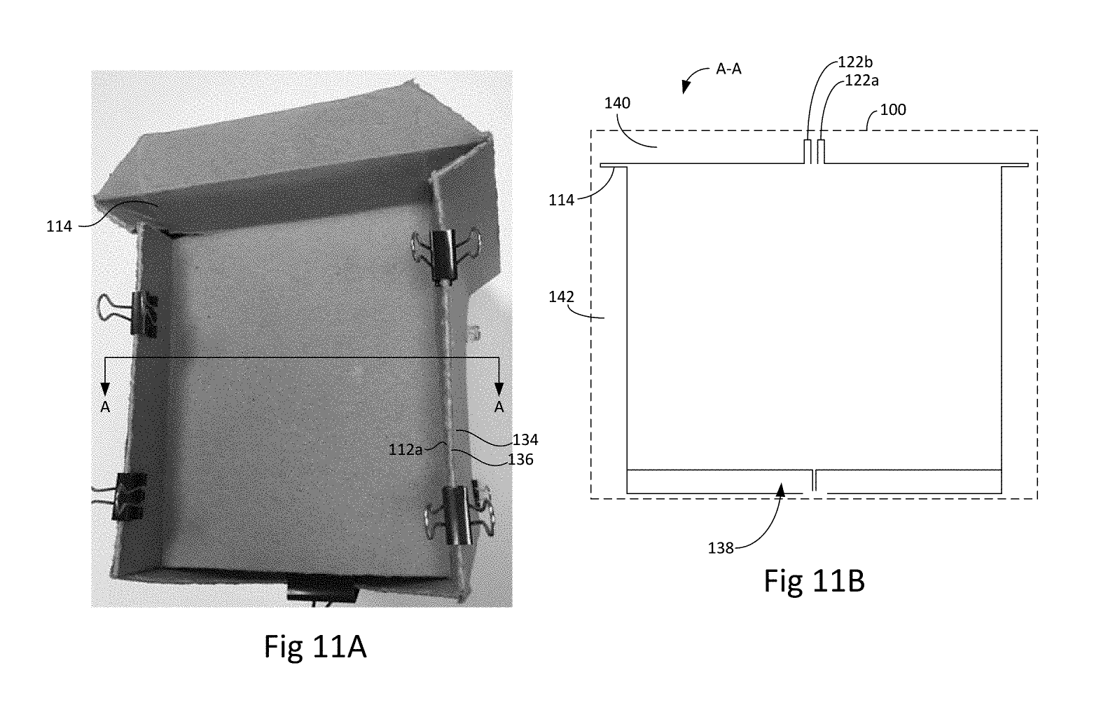

Referring to FIG. 10, the inner structure is shown in a partially erected arrangement. The bottom panel 104a is shown being hinged upwards with the bottom lateral walls hinged downward to define the bottom insulating cavity 130. Another bottom panel 104b can also hinge in a similar fashion to form a bottom insulating cavity. In one embodiment, the pair of bottom panels and their associated bottom rear walls and bottom lateral walls erect to form the bottom insulating cavity. Bottom flaps 132a and 132b can be included in the inner structure and further define the bottom insulating cavity as well as provide support articles placed in the inner cavity of the container. In one embodiment, the second side panels extend into the interior of the outer structure further than the first side panels.

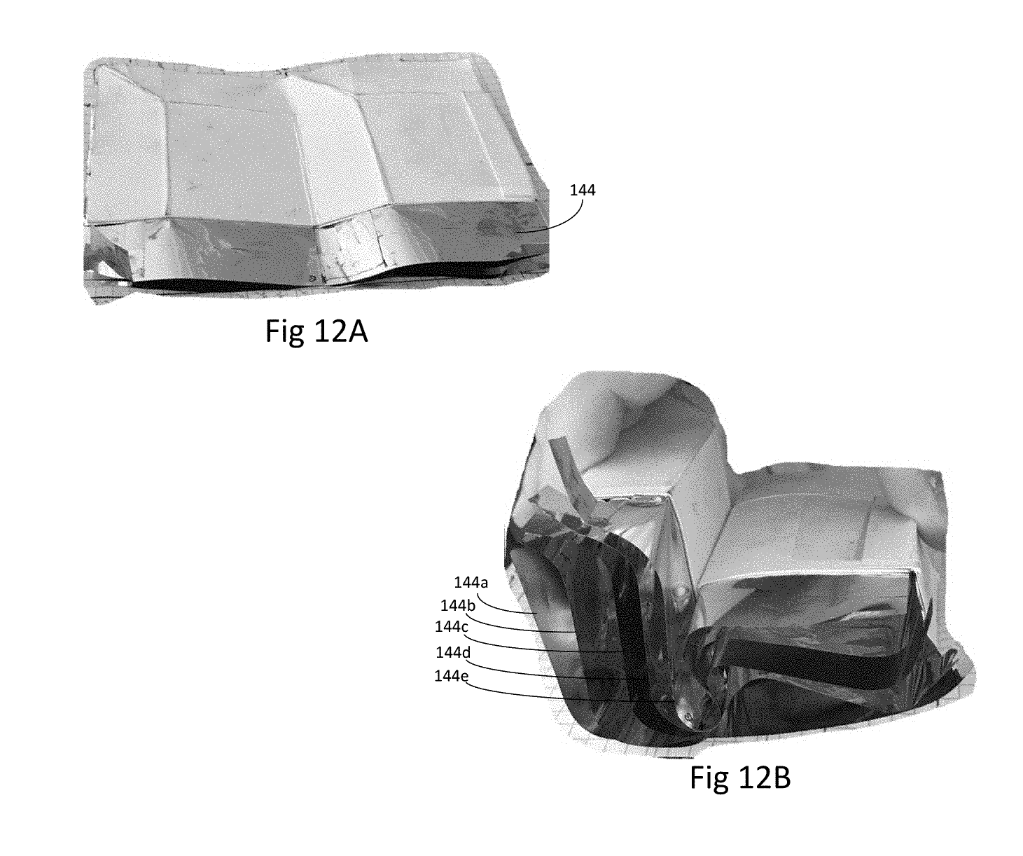

Referring to FIGS. 11A (outer structure not shown) and 11B, the inner structure is shown where a portion of the second side wall 134 folds at hinge 136 over the first side panel lateral wall. The first side panel to wall 114 is shown forming the top of the first insulating cavity when cooperatively associated with the outer structure 100. The top ridges 122a and 122b can also assist in supporting the top of the outer structure or lid to the container. The bottom panels 104a and 104b can define the bottom insulating cavity 138. The cross section of FIG. 11B shows the top insulting cavity 140 and second insulating cavity 142.

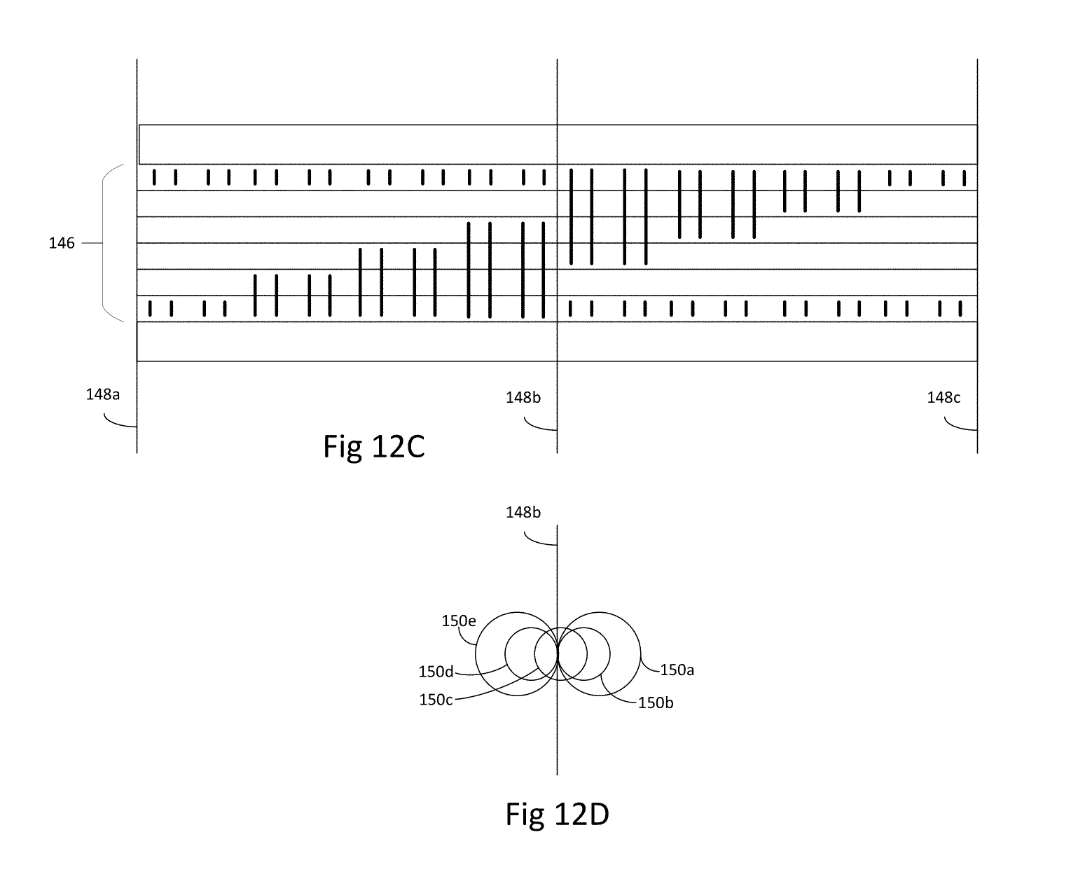

Referring to FIGS. 12A and 12B, the container can include sublayers 144 that can be disposed between the inner structure and outer structure and in one embodiment, there are a plurality of sublayers 144a through 144e. These layers can have a flat confirmation as shown in FIG. 12A for storage and shipping as well as manufacturing and an erected configuration for creating air spaces between the sublayers to provide insulating properties. In order to have the layers transition from the flat configuration to the erected configuration, the layers can be in a offset configuration allowing each layer separate from each other when erected, but adjacent to each other when in the flat configuration. As the layers can be disposed between the inner structure and the outer structure, the insulating properties of the container can be improved. In one embodiment, the layers are affixed to each other and to the inner structure and outer structure using an offer adhesion pattern 146 as shown in FIG. 12C. The offset pattern can coincide with creases 148a through 148c in the inner structure, outer structure, sublayer, or any combination.

In this embodiment, the adhesive is allowed to contact the outer structure, inner structure, and various sublayers through an overlapping perforations through the sublayer as shown in FIG. 12D. In this embodiment, the opening 150a through 150e corresponding to sublayers 144a through 144e.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

While a preferred embodiment of the invention has been described using specific terms, such description is for illustrative purposes only, and it is to be understood that changes and variations may be made without departing from the spirit or scope of the following claims.

What is claimed is:

1. A container having improved insulation properties;
an inner structure attached to an outer structure where the inner structure and outer structure form a container and define an outer cavity;
a flat configuration where the inner structure is carried by the outer structure and an internal layer is positioned between the inner structure and outer structure;
a bottom insulating cavity defined by a bottom panel, a bottom rear wall, bottom lateral walls, and outer structure when the container is in an erected configuration;
a first side insulating cavity defined by a first side panel, a first side panel lateral wall, a first side panel top wall, and the outer structure when the container is in an erected configuration;
a second insulating side cavity defined by a second side panel, a second side panel top wall, and the outer structure when the container is in an erected configuration;
a top insulating cavity defined by a top panel and the outer structure when the container is in an erected configuration; and,
a top flap having a vertical wall disposed adjacent to a top ridge and a horizontal flap disposed over the top when the container is in an erected configuration.

2. The container of claim 1 wherein the second side panel extends to the interior of the outer structure farther than the first side panel.

3. The container of claim 1 wherein a portion of the second side panel folds onto the first side panel lateral wall.

4. The container of claim 1 including a plurality of sublayers included in the internal layer arranged in an offset sublayer configuration and disposed between the outer structure and the inner structure.

5. The container of claim 4 having an offset adhesion pattern configured to apply adhesion to each sublayer to provide the offset sublayer configuration.

6. The container of claim 4 having an overlapping perforation coding pattern defined in the sublayers of the internal layer.

7. The container of claim 4 having a plurality of sublayer insulating cavities defined by the sublayers.

8. The container of claim 1 having a bottom flap attached to the second side panel.

9. A container having improved insulation properties comprising:
an inner structure for being received into an outer structure defining an inner cavity; said inner structure having a flat configuration and an erected configuration;
a bottom insulating cavity defined by a bottom panel, a bottom rear wall, and bottom lateral walls when the inner structure is in an erected configuration;
a first side insulating cavity defined by a first side panel, a first side panel lateral wall and a first side panel top wall when the inner structure is in the erected configuration;
a second insulating cavity defined by a second side panel and a second side top wall when the inner structure is in an erected configuration and cooperatively associated with an outer structure; and,
a top insulating cavity defined by a top panel and a top ridge when the inner structure is in an erected configuration and operatively associated with the outer structure.

10. The container of claim 9 wherein the outer structure includes an outer structure container for receiving the inner structure.

11. The container of claim 9 wherein the outer structure wherein the outer structure includes a flat configuration where the outer structure and the inner structure are attached to each other and superimposed.

12. The container of claim 9 including a plurality of sublayers disposed between the inner structure and the outer structure when the inner is in an erected configuration.

13. The container of claim 12 wherein the sublayers are in an offset arrangement.

14. The container of claim 9 wherein the second side panel extends into the inner cavity farther than the first side panel.

15. The container of claim 9 wherein a portion of the second side panel folds onto the first side panel lateral wall.

16. The container of claim 9 wherein a portion of the first side panel folds onto the bottom rear wall.

17. A container having improved insulation properties comprising:
an inner structure operatively associated with an outer structure;
a first set of opposing side insulating cavities including a pair of first side panels;
a second set of opposing side insulating cavities including a pair of second panels wherein the pair of first side panels and the second pair of side panels and the second pair of side panels define an inner cavity and wherein the first side panels extend into the inner cavity farther than the second side panels;
a set of bottom insulating cavities defined by a pair of bottom panels, bottom rear walls, and bottom lateral walls; and,
a top insulating cavity defined by a pair of top panels.

18. The container of claim 17 wherein the outer structure is affixed to the inner structure and the outer structure and inner structure are cooperatively associated to have a flat configuration and an erected configuration.

19. The container of claim 17 including a plurality of sublayers disposed between the inner structure and the outer structure in an offset arrangement.

20. The container of claim 17 including a top flap that forms a top ridge when the inner structure is in its erected configuration.
